(19) United States
(12) Patent Application Publication
(10) Pub. No.: US 2007/0006557 A1
(43) Pub. Date: Jan. 11, 2007

(54) Filter system for respiratory mask and method of implementing the filter system

(75) Inventors: Jui-Chi Wang, Taipei (TW); Wen-Feng Yang, Hsinchu County (TW); Shiow-Chen Wang, Taipei (TW)

Correspondence Address: BAKER & MCKENZIE LLP, Pennzoil Place, South Tower, 711 Louisiana, Suite 3400, HOUSTON, TX, 77002-2716, US

(73) Assignee: TreatYou Medical Technology Co., Taipei (TW)

(21) Appl. No.: 11/174,709

(22) Filed: Jul. 5, 2005

(51) Int. Cl. B01D 46/00

(52) U.S. Cl. 55/351

(57) ABSTRACT

A respiratory mask comprises a mask body and a filter system. The filter system includes a replaceable filter cartridge accommodating a filtration material separable into a plurality of portions, and a filter chamber connected to the mask body and configured to receive one portion of the filtration material. To change the filtration material, a user removes a first portion of the filtration material from the filter chamber, and positions a second portion of the filtration material contained inside the filter cartridge.

### FIELD OF THE INVENTION

The present invention generally relates to the construction of a respiratory mask, and more particularly to a filter system and its implementing method suitable for use with a respiratory mask.

### DESCRIPTION OF THE RELATED ART

Respiratory masks are used in a wide variety of applications for protecting a user's respiratory system from contaminates or undesirable gases present in the air, or for preventing the spread of harmful microorganisms from or to the mask's user in contamination controlled environments such as hospitals or medical laboratories.

Commercially available respiratory masks can be divided into two categories: disposable masks and non-disposable or reusable masks. A disposable respiratory mask is generally designed for a limited use in a relatively short period of time. A reusable respiratory mask usually includes replaceable filter parts that can be assembled and disassembled from the reusable mask. A replacement filter conventionally includes one or more layers of filtration materials accommodated with adequate structural components to allow the mount and dismount of the filter on the respiratory mask.

Conventionally, a reusable respiratory mask is constructed from a mask body made of a molded material and configured to fit over the wearer's face to cover the nose and mouth. The mask body usually has gas flow openings over which are fitted filter cartridges. U.S. Pat. No. 5,062,421 to Bums et al. and U.S. Pat. No. 6,298,849 to Scholey et al., the disclosures of which are incorporated herein by reference, describe exemplary constructions of a reusable respiratory mask known in the prior art. In these known constructions of respiratory mask, the filter cartridge includes a support structure that encloses a filtration material and is designed to securely mount in an accommodating space of the respiratory mask. If the user wants to change the 1o filtration material, the entire filter cartridge has to be discarded and replaced with a new one.

One disadvantage of the conventional filter construction for respiratory mask is that the change of a filtration material requires disposing of the entire filter cartridge, which includes structural parts additional to the filtration material itself. These structural parts of the filter cartridge constitute a material cost that is wasted when the filter cartridge is discarded.

Therefore, there is presently a need for an improved filter system suitable for use with a respiratory mask which can overcome the disadvantages of the prior art, is economical to produce and is easy to implement.

The present application describes a filter system suitable for use with a respiratory mask, and a method of using the filter system.

In one embodiment, a respiratory mask comprises a mask body and a filter system; the filter system includes a container accommodating a filtration material separable into a plurality of portions, and a filter chamber connected to the mask body and configured to receive one portion of the filtration material. In some embodiments, the filtration material is formed as a roll. In some embodiments, the container includes a filter cartridge configured to detachably secure with the filter chamber. In other embodiments, the container is integrated inside the filter system.

In some embodiments, the filter chamber is configured to receive a portion of the filtration material through an outlet slot of the filter cartridge. In some embodiments, the filter chamber includes a movable panel openable to allow the retrieval of a portion of the filtration material from the filter chamber. In other embodiments, the filter chamber is configured to mount a microphone.

In one embodiment, a filter cartridge suitable for use with a respiratory mask comprises a cartridge having an outlet slot, and a filtration material separable into a plurality of portions contained in the cartridge, wherein the outlet slot is configured to allow the passage of one portion of the filtration material. In some embodiments, the filtration material includes at least one scribe line. In some embodiments, a front portion of the filtration material is made of a rigid material. use with a respiratory mask. In one embodiment, the method comprises providing a filtration material separable into a plurality of portions, selecting one portion of the filtration material, and placing the selected portion of the filtration material in an adequate position for use inside the filter system. In some embodiments, the filtration material is provided inside the filter system. In other embodiments, providing a filtration material includes mounting a filter cartridge containing the filtration material to the filter system.

Furthermore, the application describes a method of changing a filtration material contained inside a filter system suitable for use with a respiratory mask. In one embodiment, the method comprises removing a first portion of the filtration material from the filter system, and providing a second portion of the filtration material inside the filter system for use with a respiratory mask.

In some embodiments, removing a first portion of the filtration material from the filter system includes opening a movable panel of the filter system, and taking out the first portion of the filtration material.

In some embodiments, removing a first portion of the filtration material unveils the second portion of the filtration material connected to the first portion of the filtration material. In some embodiments, removing the first portion of the filtration material from the filter system comprises taking out the first portion of the filtration material, and separating the first portion of the filtration material from the second portion of the filtration material. In some embodiments, separating the first portion of along a scribe line provided on the filtration material.

In some variations, the filtration material is contained in a replaceable filter cartridge of the filter system.

The foregoing is a summary and shall not be construed to limit the scope of the claims. The operations and structures disclosed herein may be implemented in a number of ways, and such changes and modifications may be made without departing from this invention and its broader aspects. Other aspects, inventive features, and advantages of the invention, as defined solely by the claims, are described in the non-limiting detailed description set forth below.

### BRIEF DESCRIPTION OF THE DRAWINGS

FIG. 1A is a perspective view schematically illustrating a respiratory mask according to an embodiment of the invention;

FIG. 1B is a perspective view of the respiratory mask of FIG. 1A taken under another angle;

FIG. 1C is a cross-sectional view of a respiratory mask according to an embodiment of the invention;

FIG. 1D is a schematic view illustrating the change of a filtration material in a respiratory mask according to an embodiment of the invention;

FIG. 2A is a perspective view of a filter cartridge suitable for use with a respiratory mask according to an embodiment of the invention;

FIG. 2B is a perspective view of a filter cartridge suitable for use with a respiratory mask according to a variant embodiment of the invention; and

FIG. 3 is a flowchart illustrating a method of implementing a filter system suitable for use with a respiratory mask according to an embodiment of the invention.

### DETAILED DESCRIPTION OF THE EMBODIMENTS

The present application describes a filter system and a method of implementing a filter system in a respiratory mask.

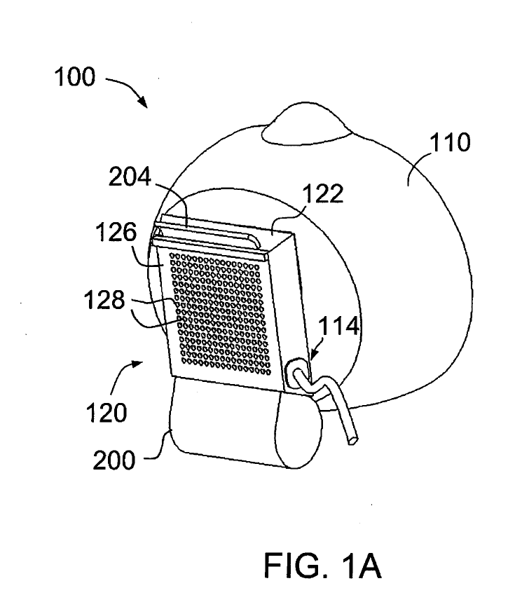

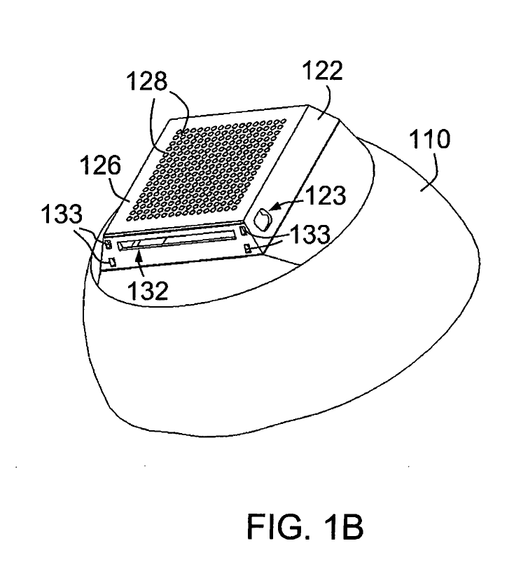

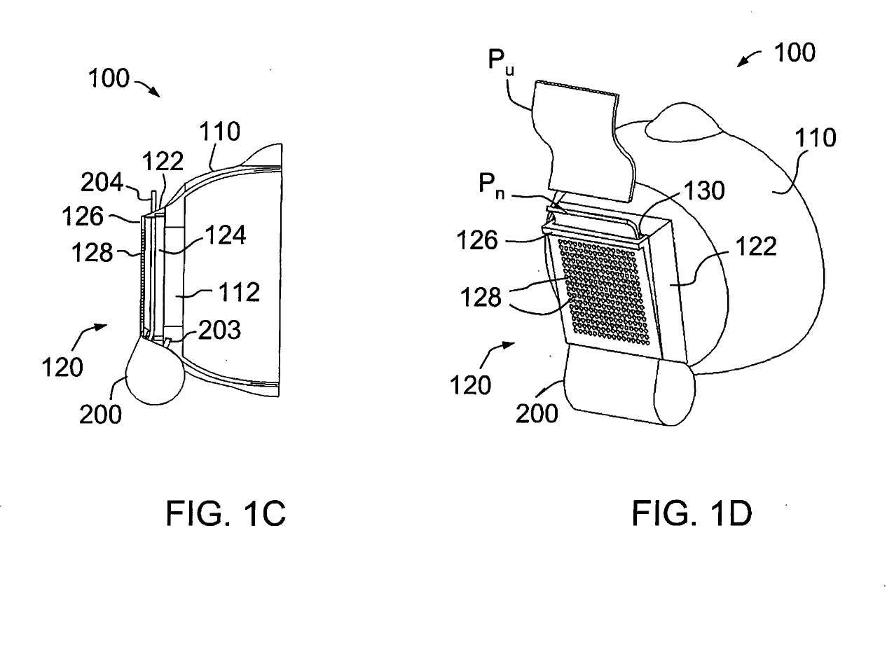

FIG. 1A is a perspective view schematically illustrating a respiratory mask according to an embodiment of the invention. A respiratory mask 100 includes a mask body 110 and a filter system 120 provided on the mask body 110. Any materials can be suitable to form the mask body 110, such as flexible resins or plastics, which allow the mask body 110 to adequately fit and cover an area of the user's face such as the mouth and the nose. A strap harness (not shown) may be attached to the mask body 110 for securing the respiratory mask 100 against the user's face. The filter system 120 includes a filter chamber 122, and a filter cartridge 200. Optionally, the filter chamber 122 may be configurable to mount a microphone 114.

FIG. 1B is a perspective view of the respiratory mask taken under another angle, and FIG. 1C is a cross-sectional view of the respiratory mask according to an embodiment of the invention. The filter chamber 122 includes an inner cavity 124 configured to receive a portion of filtration material 204, and optionally an opening 123 for receiving a microphone. The inner cavity 124 of the filter chamber 122 communicates with a gas flow opening 112 of the mask body 110 enabling the passage of a respiratory flow. The filter chamber 122 may be formed with the mask body 110 in a single body by, for example, molding; alternatively, the filter chamber 122 may be securely assembled with the mask body 110.

A movable panel 126 provided with perforations 128 is located on a front face of the filter chamber 122. Opening of the movable panel 126 defines a slit through which a filtration material 204 inside the filter chamber 122 can be pulled out. A side of the filter chamber 122 includes an inlet slot 132 and mounting holes 133 configured to mount a filter cartridge 200 from which a filtration material 204 is unrolled to feed through the inlet slot 132 into the filter chamber 122.

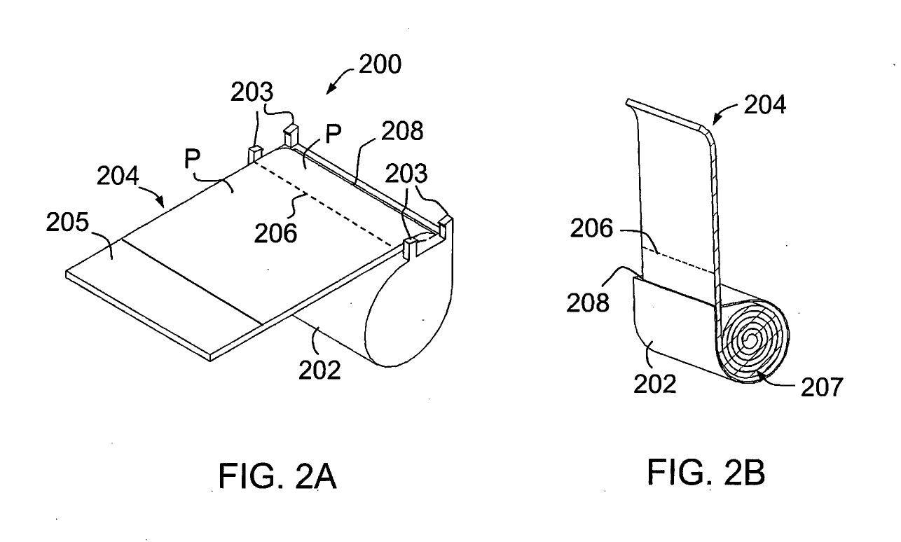

FIG. 2A is a schematic view of a filter cartridge suitable for use with a respiratory mask according to an embodiment of the invention. The filter cartridge 200 includes a cartridge case 202 configured to accommodate a filtration material separable into a plurality of portions. In this embodiment, a roll of filtration material 204 is included in the cartridge case 202. The cartridge case 202 is provided with hooked projections 203 adaptable to snap fit with the mounting holes 133 of the filter chamber 122. The roll of filtration material 204 may include transversal scribe lines 206 regularly spaced along the length of the roll to facilitate a separation of adjacent portions P of filtration material. The filtration material 204 is pulled out of the cartridge case 202 through an outlet slot 208 formed through the cartridge case 202. A front part 205 of the roll of filtration material 204 may be made of a rigid material to facilitate its passage through the inlet slot 132 of the filter system 120. Other forms different from a roll of material may be adequate for providing a filtration material separable into a plurality of portions, such as stacked sheets of filtration material.

As shown in FIG. 2B, in a variant embodiment, a side 207 of the cartridge case 202 may be made of a transparent material for determining and monitoring the amount of filtration remaining inside the cartridge case 202. Other identifying ways may be implemented to inform the user that the roll of filtration material is almost completely consumed, such as configuring the trail portions of the roll of filtration material with an indicative color.

FIG. 1D is a schematic view illustrating the change of a filtration material in a respiratory mask performed according to an embodiment of the invention. After the respiratory mask 100 has been used for a period of time or the filtration material positioned inside the filter chamber 122 of the filter system 120 is soiled, a portion of filtration material positioned inside the filter chamber 122 of the filter system 120 may need to be changed. To this end, the user opens the movable panel 126, and pulls out the used portion Pᵤ of filtration material through the slit 130, which consequently unrolls and stretches a new portion Pₙ of filtration material inside the filter chamber 122. The user then can separate the used portion Pᵤ along a scribe line to throw it away. The movable panel 126 then can be closed to prevent the clean filtration material from sliding outside, and the respiratory mask 100 is ready for use with a clean filter.

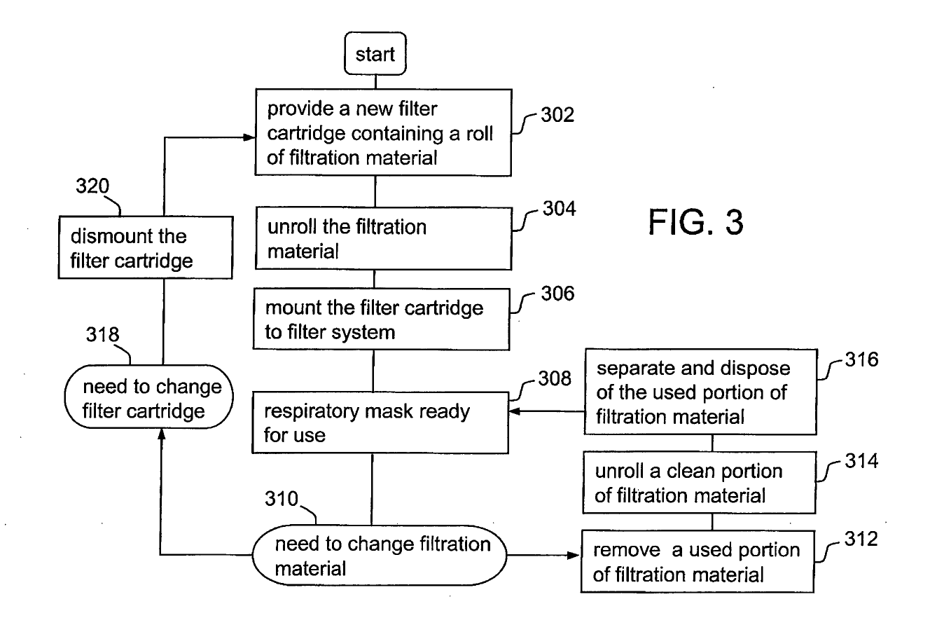

FIG. 3 is a flowchart illustrating a method of implementing a filter system suitable for use with a respiratory mask according to an embodiment of the invention. For purposes of illustration, in the present example, various steps are illustrated in a particular order; however, when supported by an adequate filter system structure, these steps can be performed in any order, serially or in parallel.

Referring to FIG. 3, the user initially acquires a filter cartridge containing a roll of filtration material (302). A portion of the roll of filtration material is unrolled (304), and the filter cartridge is mounted to a filter system of a respiratory mask with the unrolled portion of filtration adequately placed in the filter system (306). The respiratory mask then is ready for use (308).

As the respiratory mask is used for a period of time or the filtration material positioned inside the filter chamber 122 of the filter system 120 is soiled, there may be a need to change a used portion of the filtration material (310). To change the filtration material, the user removes the used portion of filtration material from the filter system (312) and unrolls a clean portion of filtration material from the filter cartridge (314). Once the newly unrolled clean portion of filtration material is correctly positioned inside the filter system, the user can separate the used portion of filtration material and throw it away (316).

As shown in FIG. 3, if the filtration material of the filter cartridge has been substantially consumed and needs to be replaced (318), the user dismounts the used filter cartridge (320), and mounts a new one according to the sequence (302)-(308).

A person skilled in the art of respiratory mask will readily appreciate that the inventive features described herein may be implemented in many variations. For example, in a disposable respiratory mask implementation, the filter chamber may be configured to include a separate compartment suitable for accommodating a roll of filtration material. In such an embodiment, the user changes a used portion of filtration material by unrolling the filtration material inside the separate compartment; once the filtration material is entirely consumed, the user can dispose of the respiratory mask with its filter system. Alternatively, the separate compartment of the filter chamber may be configured with an openable mechanism to allow the introduction of a new roll of filtration material in a reusable respiratory mask embodiment.

In other embodiments, the filter system of the respiratory mask may be provided in a kit form in which the roll of filtration material is contained in a separate portable box. If the user wishes to change the filter material of the filter system, he or she removes the used portion of filtration material from the filter chamber, unrolls and separates a clean portion of filtration material contained inside the box, and puts the clean portion of filtration material in place inside the filter system.

The filter system according to the invention thus may be advantageously implemented in reusable respiratory masks as well as disposable respiratory masks.

In addition, the filtration material may be provided in various forms different from a roll of material, such as a stack of sheets of filtration material. When the user takes out a sheet of filtration material, a next sheet of filtration material is unveiled for use with the respiratory mask.

Realizations in accordance with the present invention therefore have been described in the context of particular embodiments. These embodiments are meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope of the invention as defined in the claims that follow.

What is claimed is:

1. A respiratory mask comprising:
a mask body; and
a filter system, including:
a container accommodating a filtration material separable into a plurality of portions; and
a filter chamber connected to the mask body and configured to receive one portion of the filtration material.

2. The respiratory mask according to claim 1, wherein the filtration material is formed as a roll.

3. The respiratory mask according to claim 1, wherein the container includes a filter cartridge configured to detachably secure with the filter chamber.

4. The respiratory mask according to claim 3, wherein the filter chamber is configured to receive one portion of filtration material through an outlet slot of the filter cartridge.

5. The respiratory mask according to claim 1, wherein the container is integrated inside the filter chamber.

6. The respiratory mask according to claim 1, wherein the filter chamber includes a movable panel openable to allow the removal of one portion of filtration material from the filter chamber.

7. The respiratory mask according to claim 1, wherein the filter chamber is configured to mount a microphone.

8. The respiratory mask according to claim 1, wherein the filtration material includes at least one scribe line.

9. A filter cartridge suitable for use with a respiratory mask, the filter cartridge comprising:
a cartridge having an outlet slot; and
a filtration material contained in the cartridge, wherein the filtration material is separable into a plurality of portions.

10. The filter cartridge according to claim 9, wherein the filtration material is formed as a roll.

11. The filter cartridge according to claim 9, wherein the filtration material includes at least one scribe line.

12. The filter cartridge according to claim 9, wherein the cartridge is detachably secured with the respiratory mask.

13. The filter cartridge according to claim 9, wherein a front portion of the filtration material is made of a rigid material.

14. The filter cartridge according to claim 9, wherein the cartridge includes a transparent window for determining an amount of the filtration material inside the cartridge.

15. A method of configuring a filter system suitable for use with a 1o respiratory mask, the method comprising:
providing a filtration material separable into a plurality of portions;
selecting one portion of the filtration material; and
placing the selected portion of the filtration material in an adequate position for use inside the filter system.

16. The method according to claim 15, wherein the filtration material is formed as a roll.

17. The method according to claim 15, wherein providing a filtration material includes incorporating the filtration material inside the filter system.

18. The method according to claim 15, wherein providing a filtration material includes mounting a filter cartridge containing the filtration material to the filter system.

19. The method according to claim 15, wherein the filtration material includes at least one scribe line.

20. A method of changing a filtration material contained inside a filter system suitable for use with a respiratory mask, the method comprising:
removing a first portion of the filtration material from the filter system; and
providing a second portion of the filtration material inside the filter system for use with a respiratory mask.

21. The method according to claim 20, wherein removing a first portion of the filtration material from the filter system includes:
opening a movable panel of the filter system; and
taking out the first portion of the filtration material.

22. The method according to claim 20, wherein removing a first portion of the filtration material unveils the second portion of the filtration material connected to the first portion of the filtration material.

23. The method according to claim 22, wherein removing a first portion of the filtration material from the filter system comprises:
taking out the first portion of the filtration material from the filter system; and
separating the first portion of the filtration material from the second portion of the filtration material.

24. The method according to claim 23, wherein separating the first portion of the filtration material from the second portion of the filtration material is performed along a scribe line provided on the filtration material.

25. The method according to claim 20, wherein the filtration material is contained in a replaceable filter cartridge.
